(19) United States
(12) Patent Application Publication
(10) Pub. No.: US 2025/0327482 A1
(43) Pub. Date: Oct. 23, 2025

(54) ROLLING BEARING

(71) Applicants: Christopher Martin NOLL, Mülheim an der Ruhr (DE); Lois JACOBS, Aachen (DE); Timo SCHMITZ, Aachen (DE); Julian BERNHARD, Biberach (DE); Robert ZELL, Schemmerhofen (DE); Markus RUF, Bad Waldsee (DE); Matthias SEDLMAIER, Biberach (DE); Lennart SCHIERHOLZ, Witten (DE)

(72) Inventors: Christopher Martin NOLL, Mülheim an der Ruhr (DE); Lois JACOBS, Aachen (DE); Timo SCHMITZ, Aachen (DE); Julian BERNHARD, Biberach (DE); Robert ZELL, Schemmerhofen (DE); Markus RUF, Bad Waldsee (DE); Matthias SEDLMAIER, Biberach (DE); Lennart SCHIERHOLZ, Witten (DE)

(21) Appl. No.: 19/253,308

(22) Filed: Jun. 27, 2025

Related U.S. Application Data
(63) Continuation of application No. PCT/EP2023/087699, filed on Dec. 22, 2023.

(30) Foreign Application Priority Data
Dec. 29, 2022 (DE) 10 2022 135 001.0

(51) Int. Cl. F16C 41/00; F16C 19/36; F16C 33/34

(52) U.S. Cl. CPC F16C 41/004; F16C 19/361; F16C 33/34; F16C 41/008

(57) ABSTRACT

A rolling bearing, in particular an open-center large rolling bearing, comprising two concentric bearing rings which are rotatable relative to one another and between which there is provided at least one bearing row comprising rolling elements, wherein at least one of the rolling elements is provided with at least one sensor for detecting at least one operating parameter, a power-generating means, in particular a generator, for supplying electrical power to the sensor, and an electronic component for transmitting the sensor data to an external evaluation and/or storage unit, for supplying the sensor with electrical power, and an electronic component for transmitting the sensor data to an external evaluation and/or memory unit, wherein the power-generating means and the electronic component for transmitting sensor data are provided at opposite axial ends of the rolling element.

### CROSS-REFERENCE TO RELATED APPLICATIONS

This application is a continuation of International Patent Application Number PCT/EP2023/087699 filed Dec. 22, 2023, which claims priority to German Patent Application Number DE 10 2022 135 001.0 filed Dec. 29, 2022, which are incorporated herein by reference in their entireties.

### BACKGROUND

The present invention relates to a rolling bearing, in particular in the form of an open-center large rolling bearing, comprising two concentric bearing rings which are rotatable relative to one another and between which there is provided at least one bearing row with rolling elements, wherein at least one of the rolling elements is supplied with at least one sensor for detecting at least one operating parameter, a generator for supplying electrical power to the sensor and an electronic component for transmitting the sensor data to an external evaluation and/or memory unit.

Large rolling bearings such as those used in crane slewing gears for rotational support of the superstructure or the tower or jib of the crane, or in wind turbines for rotational mounting of the rotor hub or the rotor blades on the rotor hub, are subject not only to large forces but also to bending moments which are introduced by the crane jib or the long rotor blades and can guide to deformation of the bearing rings. Typically, the bearing rings are pressed together with high forces in one sector, while they are pulled apart with high forces in an opposite sector, so that the rolling elements along the orbit are subjected to strong compressive forces in one sector and only very low forces in the opposite sector or, depending on the design, may even lose contact with the raceways. Such large rolling bearings can be configured open-center and, regardless thereof, comprise diameters of more than half a meter or more than one meter or even more than two meters, so that the deformations of the bearing rings can assume considerable dimensions.

In order to detect the loads and the associated or resulting operating parameters such as temperature or vibration, it has already been proposed to use measuring rolling elements. Such measuring rolling elements have integrated sensors, for example in the form of strain gauges or pressure sensors, which can detect deformations of the rolling element, which can then be used to draw conclusions about the forces acting on it.

Batteries or energy storages such as rechargeable batteries or capacitors can be used to supply the sensors with electrical power. These can also be integrated into the rolling element and can be charged from the outside via suitable charging interfaces. However, charging the energy storage via such interfaces from the outside is relatively complex, as charging cables can only be connected when the vehicle is stationary. Contactless charging systems, such as inductive systems, are also difficult in practice as they require precise positioning, which is fundamentally difficult and usually also requires the storage system to be stationary.

In this respect, it has already been proposed to operate so-called “energy harvesting” on the rolling bearing itself, i.e. to generate the electrical power directly on the rolling bearing. For this purpose, it has been proposed in particular to use miniaturized generators or, in the case of large rolling bearings, generators adapted to other dimensions, which are attached partly to the rolling elements and partly to the rolling element cages or spacers in order to exploit the rotary movement of the rolling elements relative to the cage to generate electricity. In particular, permanent magnets can be attached to the cage or associated support parts, relative to which coils integrated into the rolling elements rotate so that the rotary movement of the rolling elements generates current.

Such measuring rolling elements with integrated generators are already known in different embodiments, cf. for example EP 3 857 197 B1, DE 10 2017 210 286 A1 or DE 10 2016 116 118 A1. Sensors integrated into the rolling elements are also shown in EP 0 637 734 B1, US 2018/0003227 A1 and U.S. Pat. No. 10,767,703 B2, which aim to insert an overall bolt- or pin-shaped sensor element, including batteries for power supply and a radio antenna for transmitting the sensor data, into a central bore of the rolling elements.

Even though large rolling bearings have considerable dimensions, it is still a challenge to accommodate not only the sensor system itself, but also the energy harvesting system, for example in the form of a generator with coils and magnets, as well as a data transmission interface for reading out or transmitting the sensor data in a still small rolling element, in particular if the rolling element must not be weakened too much by excessively large bores or cavities due to the high loads.

This problem of accommodation and arrangement is further exacerbated by the fact that certain sensor components are sensitive to influences from other components such as vibration, heat and energy, current or magnetic fields and are therefore sensitive in terms of their relative positioning. At the same time, all components must be balanced or arranged in such a manner that the rolling element does not become unbalanced or that no special countermeasures such as asymmetrical bores for weight compensation are necessary.

For example, EP 3 857 197 B1 shows a measuring rolling element comprising a central through-hole in which a carrier circuit board is received, which divides the bore cavity into two half-spaces, so to speak, into which there are received different components, each seated on the circuit board, such as an inductive sensor element and a radio module for data transmission. A generator for the power supply is arranged on one end-face of the rolling element, wherein on the rolling element end-face coils and on a cage part arranged adjacent thereto there are arranged magnets.

Proceeding therefrom, it is the underlying object of the present invention to create an improved rolling bearing of said type which avoids disadvantages of the prior art and further develops the latter in an advantageous manner. In particular, an integrated energy generation module is intended to supply electrical power to the sensor system and avoid charging pauses without impairing the high measuring accuracy of the sensor system or even adversely affecting the smooth running of the rolling bearing or its strength. At the same time, a simple and stable provision of the sensor data to an external storage or evaluation unit is to be achieved, for example to enable online monitoring of the bearing.

### SUMMARY

Said task is solved according to the invention by a rolling bearing according to claim 1. Preferred embodiments of the invention are the subject-matter of the dependent claims.

It is therefore proposed that the components required for sensory detection, power-generating means and data transmission are not all accommodated centrally in the interior of a rolling element bore, but are distributed in a balanced manner and that the size available on the rolling element is utilized as much as possible for this purpose. According to the invention, the generator for power-generating means on the one hand and the electronic component for sensor data transmission and possibly also storage are provided at opposite axial ends of the rolling element. Not only is space thus gained for accommodating the at least one sensor, but the electronic component is also largely prevented from being influenced by the generator, such as its eddy current fields or its temperature development. At the same time, a balanced arrangement is achieved, which avoids imbalances on the rolling element and unfavorable weight distribution.

In particular, said electronic component can be mounted outside of any bores that may be accommodated in the rolling element to accommodate sensor components or on an outer side of the rolling element. As a result, it is not necessary to make a large-volume bore in the rolling element that noticeably weakens the rolling element's rigidity or strength, or a small bore is sufficient to accommodate a sensor element. This will not only be of benefit to the deformation rigidity of the rolling element itself, but also helps to ensure that the bearing runs smoothly despite the sensor, power-generating means and electronic component.

In a further development of the invention, said electronic component may comprise a circuit board for storing and/or transmitting the sensor data, which may be arranged in a plane transverse to the axis of rotation of the rolling element, in particular perpendicular thereto, on an end-face of the rolling element. The end-face arrangement of the data transmission and/or storage board simplifies data transmission and reduces negative circumstances such as obstruction of signal transmission by the rolling element sheath or poor accessibility for a signal receiver. At the same time, the circuit board can be relatively large at the end-face without requiring a rolling element bore with a large diameter and thus weakening the strength or impairing the installation space for the sensor due to axial space requirements.

Advantageously, said circuit board can be configured annularly and/or comprise an annular enveloping surface, wherein said circuit board can be seated in an annular recess on the end-face of the rolling element. In particular, the circuit board can be recessed and/or inserted in a surface-flush manner in such an end-face recess in the rolling element, so that the circuit board does not protrude beyond the end-face of the rolling element. Despite good accessibility, a circuit board positioned in this manner does not impair the rolling element cage in particular, which can surround the rolling element at said end-face or extend along it.

Such an annular circuit board need not be configured in a closed annular shape, which it can nevertheless be, but can also be in the form of a slotted ring or a ring segment or crescent-shaped or in the manner of a three-quarter ring, or possibly also comprise two half-ring or quarter-ring parts, which can then be inserted together in said annular recess on the end-face of the rolling element.

Thanks to such an annular circuit board on the end-face of the rolling element it is possible to insert a guide pin or a stub axle or an axle pin, which may be connected to the rolling element cage, through the circuit board into the rolling element or to allow it to emerge from the rolling element on the end-face on which said circuit board is arranged. In other words, the annular circuit board does not interfere with the connection of the cage to the rolling element despite the end-face arrangement.

In particular, said rolling element may comprise a bore that passes through the circuit board coaxially to the rotary axis of the rolling element. Said stub axle or guide pin of the cage can be received in such a bore or enter the rolling element and pass through the circuit board of the electronic component.

Alternatively, the blind hole or through-hole passing through the rolling element can also be closed or covered at the end-face by said circuit board, in particular if said circuit board is not configured in an annular shape, but has a disk-shaped contour, for example.

Said bore does not have to be produced by means of a drill or need not be related to the manufacturing process by means of drilling, but can also be produced in another way, for example by eroding or cutting such as laser cutting. In this respect, the term bore is to be understood as an elongated, bore-like recess, which can nevertheless be made in the rolling element by a drill.

Said electronic component may comprise a wireless data transmission module, for example a radio module or a Bluetooth module, in order to be able to transmit the sensor data wirelessly to an external storage and/or evaluation unit. Said data transmission module can be supplied from the energy source provided on the rolling element, in particular from said generator, possibly with intermediate storage of the energy generated thereby.

Alternatively or additionally, said electronic component can also comprise another data transmission interface for transmitting the sensor data, for example a USB interface.

Irrespective of its specific configuration, said data transmission module may, in an advantageous further development of the invention, be integrated on or in said circuit board, for example by means of an integrated circuit or an integrated antenna. Alternatively, said data transmission module can also be mounted or placed on the circuit board as an additional or separate component.

Irrespective of the configuration of the data transmission module, said electronic component can be arranged co-rotating so that it rotates with the rolling element to whose end-face it is attached.

A generator part that also co-rotates with the rolling element can be attached to the end-face of the rolling element opposite the electronic component, wherein this can be one or more generator coils, for example, which can interact with permanent magnets arranged upright and attached to the cage, for example. In principle, however, a reverse arrangement would also be conceivable, according to which magnets could be arranged on the rolling element and one or more coils could be arranged vertically, for example on the stator.

In a further development of the invention, the generator can comprise a generator circuit board which is provided with one or more coils, wherein said generator circuit board, which is sometimes also referred to as powerboard, can be attached to the end-face of the rolling element in a plane transverse to the rotary axis of the rolling element, in particular perpendicular thereto. Said generator circuit board rotates with the rolling element.

In a further development of the invention, the energy indicator can also comprise several generator circuit boards, which can, for example, be arranged on top of each other, and in particular can be stacked in the axial direction of the rolling element.

Advantageously, said generator circuit board can be configured in an annular manner or define an annular envelope contour and be inserted into an annular recess in the end-face of the rolling element, wherein the generator circuit board can be recessed or positioned in a surface-flush manner in said annular recess so that the generator circuit board does not protrude beyond the end-face of the rolling element.

When such an annular generator circuit board is used, a guide pin or a stub axle or an axle pin, which can be connected to the bearing cage or the spacer for the rolling elements, can engage through the generator circuit board into a bore in the rolling element, which can be configured as a blind bore or in particular as a through bore. In the aforementioned manner, said bore does not have to be drilled, but can also be produced in another manner, for example eroded or laser-cut.

However, the one or more generator circuit boards do not have to be annular, but can also be configured in a closed disk shape, for example. Said bore through the rolling element can also be covered by said generator circuit board, wherein this can also be achieved with an annular generator circuit board in the case of one or more eccentrically placed through bores.

As an alternative to a bearing cage with a protruding stub axle that engages in the bore of the rolling element, the bearing cage can also comprise a cage pocket into which the rolling element can engage in order to be guided by the cage. Such a configuration with cage pocket and rolling element engaged therein is in particular suitable if the rolling element bore is closed by said generator circuit board- or also by the circuit board of the electronic component—but can nevertheless also be used if an annular generator circuit board or an annular circuit board of the electronic component is provided.

In a further development of the invention, magnets of the generator can be arranged opposite the end-face of said generator circuit board, for example on a cage or spacer part which extends along an end-face of the rolling element. By arranging the coils and magnets of the generator directly opposite each other on the end-face, a high level of efficiency can be achieved in energy generation even with relatively weak or small magnets. At the same time, a compact design can be achieved.

Alternatively, or in addition to such magnets arranged opposite the end-face, the generator can also comprise magnets that are arranged radially inside the generator coils, in particular in the interior of a rolling element bore made in the end-face of the rolling element.

In particular, such magnets positioned radially inside can be attached to the guide pin or stub axle or axle pin, which is connected to the cage or spacer and can engage in the end-face of the rolling element.

According to a further preferred embodiment of the invention, the generator can be configured in the form of a claw-pole generator, in which a rotor with a number of pole pairs n can rotate in a two-part stator. The two-part stator can comprise 2×n claws or yokes, wherein in a given stator position all magnetic north poles of the rotor act on one yoke and all magnetic south poles of the rotor act on the other yoke. In a claw-pole generator, the magnetic flux results from the sum of the fields between all magnetic dipoles and is guided as a sum through the annular coil. This results in an alternating magnetic field that is large in relation to the size of the coil and a good energy yield.

In particular, the rotor of such a claw-pole generator can be attached to the end-face of the rolling element, while the two-part stator can be attached to the bearing cage or the spacer for the rolling elements.

With regard to the sensor system, the bearing can be equipped in different ways, wherein advantageously several sensors or sensor elements can also be provided to detect different operating parameters. Depending on the desired monitoring, however, it may also be sufficient to provide only one sensor to detect only one operating variable.

In particular, the at least one sensor is received in a central bore or a central bore-like recess in the rolling element, wherein the sensor can be completely surrounded on the circumferential side by the material of the rolling element and/or can be received in the rolling element without axial protrusion.

In particular, in a further development of the invention, said sensor can be arranged co-rotating with the rolling element.

Advantageously, the sensor can be inserted on the circumferential side with a precise fit in said rolling element bore, in particular in such a way that deformations and/or radial loads of the rolling element can act on the sensor.

In particular, said sensor can be pressed into the rolling element or held in the rolling element bore by a press fit. Such a press fit not only transfers deformations and loads of the rolling element directly to the sensor, but can also ensure sensitive sensory detection of other operating parameters such as temperature or vibration.

As an alternative to being pushed in, the sensor can also be molded in, for example by a heat-transmitting and/or force- and/or shock-transmitting material, depending on which measuring variable the at least one sensor is to detect.

Advantageously, said sensor can be configured to operate resistively, although other sensor principles can also be used in principle. For example, a piezo sensor or a capacitive sensor can be used.

For example, one or more strain gauges can also be used as a sensor, which can be placed in said recess in the interior of the rolling element. In particular, such a strain gauge or strain gauges can be applied, for example glued, to the inner circumferential wall that defines the bore or recess in the interior of the rolling element. Such strain gauges can be used in addition to or as an alternative to said push-in sensor, wherein such strain gauges are easier to mount or the through-hole recess is easier to manufacture in this case with regard to the dimensional tolerances than is the case with said push-in sensor.

In an advantageous further development, several strain gauges can be arranged distributed over the axial length of the inner recess or provided at different axial positions in order to obtain information about deformations of the rolling element in different axial sections. Alternatively or additionally, several strain gauges can also be provided at an axial position, in particular distributed in circumferential direction on the inner wall of the through bore or recess.

By using several distributed strain gauges, even uneven or more complex deformations of the rolling element can be precisely characterized or detected by sensors.

At least one of the following sensors can be integrated in said rolling element or mounted on the rolling element in said manner: a vibration sensor, a rotation angle sensor, an angular position sensor, a rolling element load sensor, a shape sensor for detecting load-induced rolling element contractions and/or a rolling element ovalization, a temperature sensor, a deformation sensor, an acceleration sensor, a rotational speed sensor and an inertial measuring unit IMU as well as a magnetometer for measuring magnetic field strengths.

### BRIEF DESCRIPTION OF THE DRAWINGS

The invention is explained in more detail below using a preferred exemplary embodiment and corresponding drawings. The drawings show:

FIG. 1: a sectional view through a rolling bearing with a measuring rolling element according to an advantageous embodiment of the invention,

FIG. 2: a schematic, perspective exploded view of a claw-pole generator for power-generating means in a rolling element of the rolling bearing, and

FIG. 3: a sectional view through a rolling bearing according to a further embodiment of the invention, showing a rolling element and the cage surrounding it, wherein an energy storage device and sensors in the form of strain gauges are also provided in the interior of the rolling element.

### DETAILED DESCRIPTION

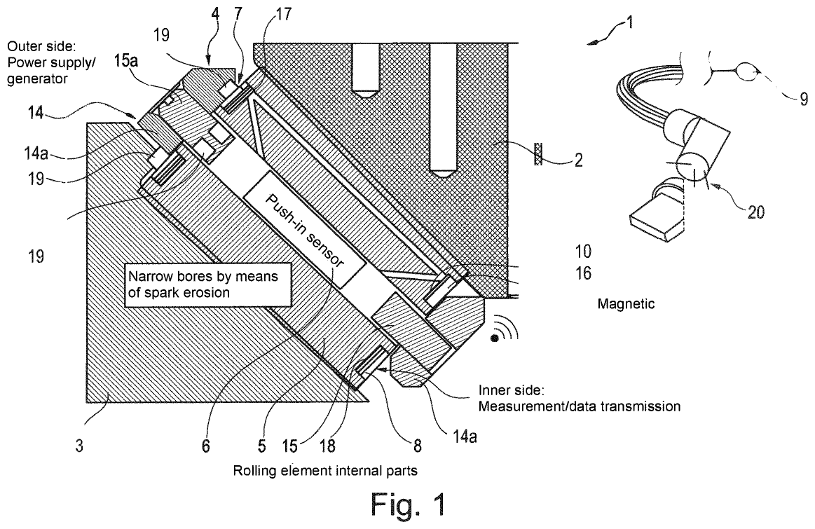

As shown in FIG. 1, the rolling bearing 1 can comprise two bearing rings 2, 3, which are arranged concentrically to each other and can be rotated relative to each other. In particular, said rolling bearing 1 can be configured as an open-center large rolling bearing with a diameter of more than half a meter or more than one meter.

As further shown in FIG. 1, the bearing rings 2, 3 can be supported against each other by only a single bearing row 4, wherein several bearing rows can also be provided to support the bearing rings 2, 3 against each other. The one or more bearing rows 4 can comprise an axial bearing or a radial bearing. Alternatively, or additionally, a bearing row 4 can also be provided that can transmit both axial forces and radial forces, for example in the form of a tapered roller bearing or an angular contact roller bearing with inclined cylindrical rollers.

The at least one bearing row 4 comprises a plurality of rolling elements 5, each of which rolls on raceways on the bearing rings 2, 3 and thereby supports the bearing rings 2, 3 against each other. A cage 14 can keep the rolling elements 5 at a distance or guide them relative to each other, wherein the cage 14 can comprise cage sections 14a extending along the end-faces of the rolling elements 5 on one or both sides, cf. FIG. 1. In particular, said cage sections 14a can form cage rings, which can extend along the inside and outside of the rolling elements 5.

As further shown in FIG. 1, the bearing cage 14 can comprise cage axes 15 in the form of stub axles, which can engage at the end-face in a rolling element bore 13 in order to guide the rolling element 5. Said cage axes 15 in the form of the stub axles 15a can be attached to the aforementioned cage sections 14a, cf. FIG. 1.

The rolling elements 5 can comprise cylindrical rollers, tapered rollers, fir rollers or possibly also balls, wherein several of these rolling element types can also be provided in the rolling bearing 1 if there is more than one bearing row. If balls are provided, said “end-faces” mean the opposite sides of the ball on which the cage elements 14a or the stub axles 15a are provided and/or on which the imaginary axis of rotation 11 of the rolling element 5 emerges from the respective ball. In particular, however, cylindrical or conical or spherical rolling elements 5 can be provided, as shown in FIG. 1.

Said bore 13 through the rolling element 5 can be a through bore through the entire rolling element and can be arranged coaxially to its axis of rotation 11.

The rolling element 5 is configured as a measuring rolling element and has an integrated sensor system with at least one sensor 6, which can be received in said bore 13. Said sensor 6 can in particular be pressed into the bore 13 so that the bore wall firmly encloses the outer wall of the sensor in order to transmit deformations or an ovalization of the rolling element 5 to the sensor 6 or to be able to measure through it.

Irrespective thereof, said sensor 6 can be configured to operate resistively in particular.

Said sensor 6 can be arranged between a power-generating means, for example in the form of a generator 7, and an electronic component 8 for storing and transmitting the sensor data, wherein said power-generating means and the electronic component can be arranged on opposite end-faces of the sensor 6.

As shown in FIG. 1, the electronic component 8 can be arranged outside the bore 13, in particular on an end-face of the rolling element 5.

The electronic component 8 can advantageously comprise a circuit board 10, which can be configured in an annular shape and can be positioned around the aforementioned bore 13 on the end face of the rolling element.

The end-face of the rolling element can advantageously comprise an annular recess at its end-face, in which said annular circuit board 10 can be arranged recessed, so that the electronic component 8 does not protrude beyond the end-face of the rolling element 5.

A data transmission module can be provided on the circuit board 10, for example in the form of a radio or Bluetooth module. Alternatively, or additionally, a USB interface can also be provided, for example in the form of a magnetic USB interface, so that a magnetic USB cable 20 can be connected to the circuit board 10 in terms of signal technology.

Said circuit board 10 may also comprise a memory module in which the sensor data collected by the sensor 6 can be stored or temporarily stored before being transmitted to an external evaluation unit 9 via the data transmission module. Said evaluation unit 9 can be an electronic computing unit with a processor, a program memory and a working memory in order to be able to execute evaluation routines, for example in the form of stored software.

As shown in FIG. 1, the electronic component 8 on the outside of the rolling element 5 can be connected to the sensor 6 by a data line in order to be able to receive or query the sensor signals. Furthermore, the electronic component 8 can also be connected to the power-generating means, for example in the form of the generator 7, via a supply line in order to be supplied with electrical power by the power-generating means.

Said power-generating means also supplies the sensor 6 with electric current, which can be connected to said power-generating means via a further power line.

Without FIG. 1 explicitly showing this, an intermediate storage device can also be provided between the power-generating means and the components to be supplied, such as the sensor 6 and/or the electronic component 8, for intermediate storage of the generated electrical power, for example in the form of a battery and/or a rechargeable battery and/or a capacitor, which could also be arranged in the interior of the rolling element 5.

As further shown in FIG. 1, the generator 7 can be arranged on the end-face of the rolling element 5 opposite the electronic component 8, wherein a generator circuit board 17 similar to the circuit board 10 of the electronic component 8 can be configured annularly and arranged recessed in an annular recess 18 on the end-face of the rolling element 5, so that the generator circuit board 1 does not protrude beyond the end-face of the rolling element.

Said generator circuit board 17 may comprise one or more coils which may cooperate with permanent magnets 19.

Said permanent magnets 19 can be arranged opposite the end-face of the generator circuit board 17, in particular attached to the cage 14. Advantageously, the magnets 19 can be arranged on a pitch circle whose diameter essentially corresponds to the pitch circle on which the coils of the generator circuit board 17 are arranged. In other words, the coils and the permanent magnets 19 can be arranged approximately equidistant from the axis of rotation 11 and directly opposite each other at the end-face, cf. FIG. 1.

Alternatively, or additionally, permanent magnets 19 can also be arranged radially within the generator circuit board 17 in order to induce current in the coils of the generator circuit board 17. For example, the magnets 19 can be arranged on one of the axle stubs 15a of the bearing cage 14 and positioned recessed in the bore 13, cf. FIG. 1.

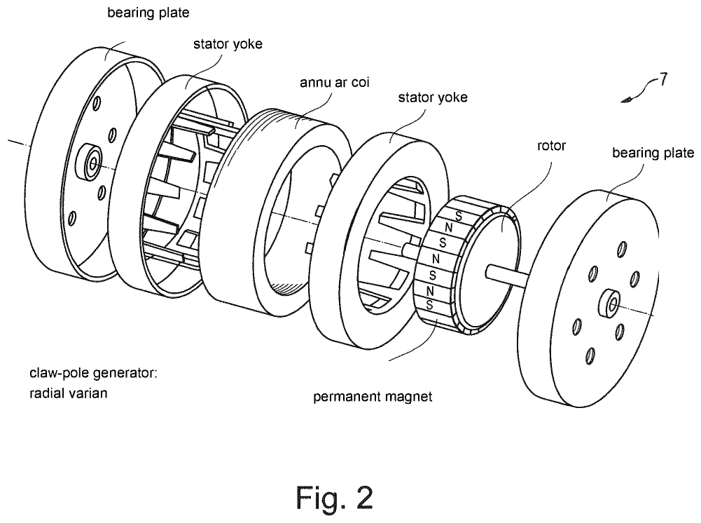

According to a further advantageous embodiment of the invention, the power-generating means may also comprise a claw-pole generator, cf. FIG. 2.

Such a claw-pole generator can advantageously also be positioned on the end-face of the rolling element 5, in particular on the end-face opposite the electronic component 8.

As previously explained, the rotor of such a claw-pole generator can rotate with a number of pole pairs n in a two-part stator, cf. FIG. 2.

The two-part stator can comprise 2×n claws or yokes, wherein in a given stator position all magnetic north poles of the rotor act on one yoke and all magnetic south poles of the rotor act on the other yoke. In a claw-pole generator, the magnetic flux results from the sum of the fields between all magnetic dipoles and is guided as a sum through the annular coil. This results in an alternating magnetic field that is large in relation to the size of the coil and a good energy yield.

In particular, the rotor of such a claw-pole generator can be attached to the end-face of the rolling element, while the two-part stator can be attached to the bearing cage or the spacer for the rolling elements.

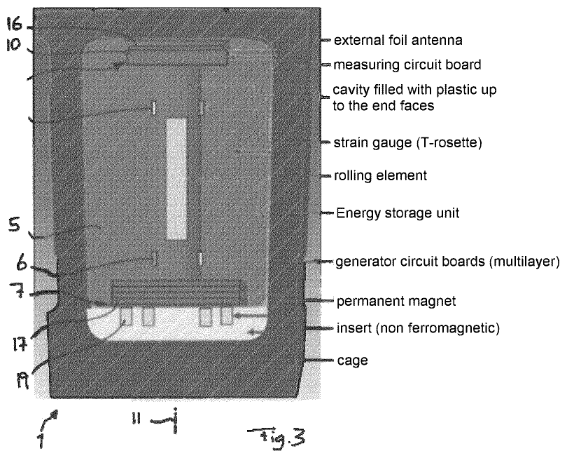

As shown in FIG. 3, an energy storage 21 can also be accommodated in the interior of the rolling element 5, wherein the energy storage 21 can, for example, be positioned centrally or approximately in the middle of the rolling element bore 13. This can be advantageous because or if the energy storage 21 comprises a relatively high weight compared to the other components.

Advantageously, a lithium polymer battery can be provided as energy storage, although in principle other batteries or rechargeable energy storage devices can also be used.

As further shown in FIG. 3, said energy storage 21 is accommodated in the interior of the rolling element 5 in addition to the at least one sensor 6. Irrespective of the use of said energy storage 21, a strain gauge can be provided as sensor 6, wherein advantageously several strain gauges can also be accommodated in the interior of the rolling element 5, wherein such strain gauges can advantageously be attached, in particular glued, to the inner circumferential wall of the rolling bearing bore 13.

In order to also be able to detect non-uniform or more complex deformations of the rolling element 5, several strain gauges are advantageously mounted distributed over the axial length of the bore 13 or provided at several axial positions, cf. FIG. 3. Alternatively or additionally, several strain gauges can also be provided at an axial position, in particular distributed in the circumferential direction and glued to the bore wall.

As further shown in FIG. 3, the circuit board 10 of the electronic component 8 can also be configured as a continuous disk and/or close the end-face of the rolling element bore 13. Irrespective thereof, the circuit board 10 can be received recessed in an end-face recess of the rolling element 5, cf. FIG. 3.

Irrespective of thereof, a foil antenna can be provided on said circuit board 10 as a data transmission module 16. As previously mentioned, however, the data transmission module can also be integrated into the circuit board 10.

As further shown in FIG. 3, the generator 7 can comprise several generator circuit boards 17, which can be provided stacked on top of one another. Irrespective thereof, the at least one generator circuit board 17, as shown in FIG. 3, can also be configured to be closed or non-annular.

The end-face of the rolling element bore 13 can be closed by said one or more generator circuit boards, cf. FIG. 3. The one or more generator circuit boards are advantageously arranged recessed in an end-face recess of the rolling element, cf. FIG. 3.

In a further development of the invention, the magnets 19 cooperating with the one or more generator circuit boards 17 can be positioned or mounted in a component made of a non-ferromagnetic material, which can, for example, be configured in the form of a disk. Irrespective thereof, said component to which the magnets 19 are attached can be firmly connected to the cage 14, said component being positioned opposite the end face of the rolling element, cf. FIG. 3.

As can be seen from the figures, the rolling bearing 1 is characterized in particular by the following aspects:
One aspect is that the power-generating means 7 and the electronic component 8 for transmitting sensor data are provided at opposite axial ends of the rolling element 5.
A further aspect is that the electronic component 8 comprises a circuit board 10 for data storage and/or transmission, which is arranged in a plane transverse to the axis of rotation 11 of the rolling element 5 on an end-face of said rolling element 5.
A further aspect is that the circuit board 10 is configured in an annular manner and/or defines an annular envelope contour, wherein said circuit board 10 is recessed in an annular recess 12 in the end-face of the rolling element 5 and/or is inserted in a surface-flush manner.
A further aspect is that the rolling element 5 comprises a bore 13 which passes through the circuit board 10 coaxially with the rotary axis of the rolling element 11.
A further aspect is that a bearing cage 14 comprises a cage axis 15 which engages in the end-face of the rolling element 5 and/or passes through the rolling element and which passes through said circuit board 10.
A further aspect is that the electronic component 8 is arranged co-rotating with the rolling element 5.
A further aspect is that said electronic component 8 comprises a wirelessly operating data transmission module 16, in particular a radio and/or Bluetooth transmission module.
A further aspect is that the at least one sensor 6 is seated in a central bore 13 in the rolling element 5.
A further aspect is that the at least one sensor 6 is arranged co-rotating with the rolling element 5.
A further aspect is that the at least one sensor 6 is seated on the circumferential side with a precise fit in the rolling element 5 in such a way that deformations and/or vibrations of the rolling element 5 are transmitted directly to the sensor 6.
A further aspect is that the at least one sensor 6 is pressed into the rolling element 5 and/or is held in the rolling element 5 by a press fit.
A further aspect is that the at least one sensor 6 comprises at least one of the following sensor elements: a vibration sensor, a rotation angle sensor, an angular-position sensor, a rolling element load sensor, a shape sensor for detecting load-induced rolling element contractions and/or a rolling element ovalization, a temperature sensor, a deformation sensor, an acceleration sensor, a rotational speed sensor and an inertial measuring unit IMU as well as a magnetometer for measuring magnetic field strengths.
Another aspect is that the sensor 6 is configured to operate resistively.
In a further aspect, the power-generating means comprises a generator circuit board with one or more coils arranged in a plane transverse to the axis of rotation 11 of the rolling element 5 at the end-face of said rolling element 5.
A further aspect is that the generator circuit board 17 is configured in the shape of an annular ring and/or defines an annular envelope contour, wherein said generator circuit board 17 is recessed or received in a surface-flush manner in an end-face, in particular an annular recess 18 in the end-face of the rolling element 5.
A further aspect is that the rolling element 5 comprises a bore 13 which passes through the generator circuit board 17 coaxially with the rotary axis of the rolling element 11.
A further aspect is that a bearing cage 14 comprises a cage axis 15 which engages in the end-face of the rolling element 5 and/or passes through the rolling element and which passes through said generator circuit board 17.
A further aspect is that the power-generating means comprises permanent magnets arranged radially within generator coils on said cage axis 15.
A further aspect is that the power-generating means comprises permanent magnets which are arranged opposite the end-face of the rolling element 5 and/or at approximately the same distance from the rotary axis of the rolling element 11 as generator coils.
Another aspect is that the power-generating means comprises a claw-pole generator.

We claim:

1. A rolling bearing comprising an open-center large rolling bearing comprising two concentric bearing rings rotatable relative to one another, further comprising at least one bearing row between the two concentric bearing rings, wherein the at least one bearing row comprises rolling elements, wherein at least one of the rolling elements comprises a sensor for detecting at least one operating parameter, a power generator comprising a generator, wherein the power-generator is for supplying electrical power to the sensor, and an electronic component for transmitting the sensor data to an external evaluation and/or memory unit, wherein the power generator and the electronic component for transmitting sensor data are at opposite axial ends of the rolling element.

2. The rolling bearing of claim 1, wherein the electronic component comprises a circuit board for data storage and/or transmission, wherein the circuit board is in a plane transverse to an axis of rotation of the rolling element on one end-face of said rolling element.

3. The rolling bearing of claim 2, wherein the circuit board is annular and/or defines an annular envelope contour, wherein the circuit board is recessed and/or inserted in a surface-flush manner into an annular recess in the end-face of the rolling element.

4. The rolling bearing of claim 3, wherein the rolling element comprises a bore which passes through the circuit board coaxially to the rotary axis of the rolling element.

5. The rolling bearing according to claim 2, wherein the rolling element comprises a bore coaxial to the axis of rotation of the rolling element and is covered on the end-face by at least one circuit board.

6. The rolling bearing of claim 5, wherein a bearing cage comprises a cage axis which engages in the end-face of the rolling element and/or passes through the rolling element and which passes through the circuit board.

7. The rolling bearing of claim 1, wherein the electronic component is configured to co-rotate with the rolling element.

8. The rolling bearing of claim 1, wherein the electronic component comprises a wirelessly operating data transmission module comprising a radio and/or a Bluetooth transmission module.

9. The rolling bearing of claim 8, wherein the data transmission module is integrated into one/the circuit board of the electronic component or lies flat thereon as a separate component.

10. The rolling bearing of claim 1, wherein the at least one sensor is seated in a central bore in the rolling element.

11. The rolling bearing of claim 1, wherein the sensor is configured to co-rotate with the rolling element.

12. The rolling bearing of claim 1, wherein the sensor is seated on the circumferential side with a precise fit in the rolling element so deformations and/or vibrations of the rolling element are transmitted directly to the sensor.

13. The rolling bearing of claim 1, wherein the sensor is pressed into the rolling element and/or is held in the rolling element via a press fit.

14. The rolling bearing of claim 1, wherein the sensor comprises a strain gauge in an interior of the rolling element, and wherein the strain gauge is glued to an inner circumferential wall of the rolling element.

15. The rolling bearing of claim 14, wherein a first plurality of strain gauges are arranged at different axial positions in the interior of a/the rolling element bore distributed in the longitudinal direction thereof and/or a second plurality of strain gauges are arranged at an axial position distributed in the circumferential direction thereof.

16. The rolling bearing of claim 1, wherein the sensor comprises at least one of the following sensor elements: a vibration sensor, a rotation angle sensor, an angular-position sensor, a rolling element load sensor, a shape sensor for detecting load-induced rolling element contractions and/or a rolling element ovalization, a temperature sensor, a deformation sensor, an acceleration sensor, a rotational speed sensor and an inertial measuring unit IMU as well as a magnetometer for measuring magnetic field strengths.

17. The rolling bearing of claim 1, wherein the sensor is configured to operate resistively.

18. The rolling bearing of claim 1, wherein the electronic component is configured to detect the measuring variables of the sensor onboard.

19. The rolling bearing of claim 1, wherein the power generator comprises at least one generator circuit board with one or more coils in a plane transverse to the axis of rotation of the rolling element at the end-face of said rolling element.

20. The rolling bearing of claim 19, wherein several generator circuit boards are stacked on top of each other.

21. The rolling bearing of claim 20, wherein the generator circuit board is annular and/or defines an annular envelope contour, wherein the generator circuit board is recessed or received in a surface-flush manner in an end-face recess comprising an annular recess in the end-face of the rolling element.

22. The rolling bearing of claim 21, wherein the rolling element comprises a bore which passes through the generator circuit board coaxially to the axis of rotation of the rolling element.

23. The rolling bearing of claim 21, wherein the rolling element comprises a bore which is coaxial to the axis of rotation of the rolling element and is closed or covered on the end-face by the at least one generator circuit board.

24. The rolling bearing of claim 23, wherein a bearing cage comprises a cage axis which engages in the end-face of the rolling element and/or passes through the rolling element and which passes through said generator circuit board.

25. The rolling bearing of claim 24, wherein the power generator comprises permanent magnets arranged radially within generator coils on said cage axis.

26. The rolling bearing of claim 1, wherein a bearing cage comprises a cage pocket into which the rolling element engages and through which the rolling element is guided.

27. The rolling bearing of claim 2, wherein the power-generating element comprises permanent magnets opposite the rolling element on the end-face and/or at the same distance from the axis of rotation of the rolling element as generator coils.

28. The rolling bearing of claim 27, wherein the magnets are arranged or mounted in or on a support member of non-ferromagnetic material fixedly connected to the bearing cage.

29. The rolling bearing of claim 1, wherein the power generator comprises a claw-pole generator.

30. The rolling bearing of claim 1, wherein an energy storage comprising one or more lithium polymer rechargeable batteries, is received in an interior of the rolling element.

31. The rolling bearing of claim 4, wherein the rolling element bore and/or end-face recesses on the rolling element is/are cast and/or foamed with a casting and/or foaming material for the protection and/or positioning of components accommodated therein.
